(19) United States
(12) Patent Application Publication
(10) Pub. No.: US 2020/0332591 A1
(43) Pub. Date: Oct. 22, 2020

(54) Privacy Window System

(71) Applicant: Karl Allen Dierenbach, Centennial, CO (US)

(72) Inventor: Karl Allen Dierenbach, Centennial, CO (US)

(21) Appl. No.: 16/584,588

(22) Filed: Sep. 26, 2019

Related U.S. Application Data
(60) Provisional application No. 62/834,701, filed on Apr. 16, 2019.
(60) Provisional application No. 62/837,508, filed on Apr. 23, 2019.

(51) Int. Cl. E06B 9/24; E04B 2/90; G09F 13/10; G09F 19/22; G09F 19/14; G09F 27/00

(52) U.S. Cl. CPC E06B 9/24; E04B 2/90; G09F 13/10; G09F 2013/045; G09F 19/14; G09F 27/00; E06B 2009/2464; G09F 19/22

(57) ABSTRACT

A privacy window that provides three distinct benefits simultaneously and under all lighting conditions. First, the privacy window allows natural light to pass through a translucent portion and enter a room. Second, the privacy window allows an observer inside the room to observe the environment immediately outside of the room. Third, the privacy window prevents an observer outside of the room from observing details within the room through the privacy window.

### CROSS-REFERENCE TO RELATED APPLICATIONS

This application claims priority to prior U.S. Provisional Patent Application Ser. No. 62/834,701, filed Apr. 15, 2019, titled “Privacy Window System,” the entirety of which is hereby incorporated by reference. This application also claims priority to prior U.S. Provisional Patent Application Ser. No. 62/837,508, filed Apr. 23, 2019, titled “Privacy Window System,” the entirety of which is hereby incorporated by reference.

### FIELD OF THE INVENTION

The present invention relates to systems designed to provide privacy regarding an opening of a room, such as a window of a building. The systems allow an occupant of the room to observe the exterior of the room through the opening while simultaneously preventing an observer outside of the room from seeing the interior of the room through the opening.

### BACKGROUND OF THE INVENTION

Windows have long been used to allow occupants of a room to observe details of the environment outside of the room while also allowing natural light from outside to enter the room. However, the two features of observation of the external environment and natural light transmissivity have always been in conflict with the desire for privacy.

One early, and still common, attempt to provide privacy is a shear curtain, which maintains natural light transmissivity and provides privacy in that an observer outside of the room is unable to observe details within the room. However, such a shear curtain also prevents the occupants of the room from observing details of the environment outside of the room.

Another early attempt to provide privacy is to use translucent glass, such as stained or frosted glass, in a window. Such glass provides privacy and natural light transmissivity while preventing outside observers from seeing any details through the glass. However, such translucent glass also prevents the occupants of the room from observing details of the environment outside of the room.

Another common method of providing privacy is the use of glass with a reflective film which provides a one-way mirror effect. A reflective film relies on a significant difference in light levels on opposite sides of a window. For example, during a sunny day, the light level outside of the window will generally be much greater than the light level in the room. Under such conditions, an observer outside of the room is unable to observe details within the room since the reflective film gives the window a mirror-like appearance. Meanwhile, an observer inside of the room is able to observe the environment outside of the room through the film. Light is also able to pass through the window from the outside environment and into the room, although at reduced levels due to a tinting effect of the film. However, at night the room light level is typically greater than the light level outside of the window and the effect is reversed, preventing an observer inside of the room from observing the environment outside of the room while allowing an observer outside of the room to easily observe details within the room. Under conditions where the interior light level is close to or greater than the exterior light level, reflective film provides little or no privacy.

It has long been recognized that a window in a room allowing observation of the outside of the room is desirable. To that end, window substitutes for rooms that do not have windows have been developed. One such substitute is described in U.S. Pat. No. 5,253,051, by McManigal, issued Oct. 12, 1993, where an artificial window for a windowless room is described. The artificial window includes a video structure to effect video presentation at the artificial window, thus simulating an actual window. However, such a window does not allow natural light from outside of the room to enter the room through the window.

Accordingly, there is a long felt but unresolved need for a window which is able to simultaneously, and under all conditions, provide complete privacy (i.e., an observer outside the window is unable to observe details within the room), natural light transmissivity, and allow room occupants to observe details of the environment outside the window.

### SUMMARY OF THE INVENTION

In the following description, the invention is set forth in the context of window apparatuses and related methods for simultaneously providing complete privacy, natural light transmissivity, and external environment observation. Natural light transmissivity may be achieved through the use of translucent material. As used herein, “glass” may refer to any appropriate material or glass type that may be used where glass is traditionally used, such as, for example, quartz, acrylic (e.g., Plexiglas), and/or polycarbonate resin (e.g., Lexan).

In a first embodiment of a privacy window, the privacy window comprises an opening in a wall, a translucent portion, an electronic display, a camera, and an interconnection between the electronic display and the camera. The opening in the wall may be disposed between an interior of the room and an exterior of the room. The translucent portion may be disposed within a first portion of the opening. The electronic display may be disposed within a second portion of the opening. The electronic display includes a display surface and a permanently opaque rear surface. The display surface faces the interior of the room. The electronic display is operable to display video on the display surface. The camera may be positioned such that it is operable to capture a video stream of a view of the exterior of the room. Such a view would be at least partially visible to a first observer within the room if a portion of the translucent portion were transparent. The interconnection between the electronic display and the camera is operable to enable the electronic display to display at least a portion of the video stream. The translucent portion and the electronic display are disposed such that a second observer outside of the room is substantially unable to observe details within the room through the privacy window. In an aspect of the present embodiment, the exterior of the room may be an exterior of a building. The translucent portion may include at least one of privacy glass, glass block, frosted glass, stained glass, translucent polymer, and translucent film.

At least a first portion of the translucent portion may be movable between a closed position and an open position. In such an aspect, the open position may be configured such that the second observer outside of the room is substantially unable to observe details within the room through the privacy window when the first portion of the translucent portion is in the open position. In an alternative aspect, no portion of the privacy window may be operable to be opened.

In an aspect, the first portion of the opening and the second portion of the opening together substantially make up an entirety of the opening.

Substantially an entirety of the second portion of the opening facing the exterior of the room may be covered with glass.

The privacy window may further comprise muntins disposed between and/or within the first portion of the opening and the second portion of the opening.

No portion of video displayed on the display surface may be visible from the exterior of the room through the privacy window.

The second observer outside of the room may be substantially unable to observe details within the room through the privacy window when the privacy window is in a zero power state.

The translucent portion and the electronic display may be disposed such that an observer in the room is substantially unable to observe details of the exterior of the room through the privacy window other than by observing the video stream on the display surface.

The camera may be positioned within a perimeter of the opening. The camera may be positioned within the opening. The camera may be interconnected to an adjustable mount, wherein the adjustable mount is operable to adjust a direction that the camera is pointing.

The privacy window may be operable to simultaneously: provide light from the exterior of the room to the interior of the room through the translucent portion; provide the first observer the video stream of the view of the exterior of the room; and prevent the second observer from substantially observing details within the room through the privacy window.

The privacy window may further include a microphone operable to receive an audio stream from the exterior of the room proximate to the privacy window. The privacy window may further include a sound generating apparatus operable to reproduce the audio stream within the interior of the room.

The privacy window may further comprise a light source operable to project light from the privacy window toward the exterior of the room. Such a light source may include at least one of a visible light source and an infrared light source.

The privacy window may further comprise: a first light sensor operable to detect an interior light level of the interior of the room; a second light sensor operable to detect an exterior light level of the exterior of the room; and a brightness controller operable to adjust a brightness of the electronic display at least partially based on the interior light level and the exterior light level.

The privacy window may further comprise a sensor operable to detect an occupancy status within the interior of the room and a controller operable to change the power state of the electronic display based on the occupancy status.

In an aspect of the privacy window, the electronic display may be comprised of at least two discrete portions. In a variation of the current aspect, a portion of the translucent portion may be disposed between the discrete portions. The video stream may be divided between the at least two discrete portions such that substantially no portion of the video stream appears on more than one of the at least two discrete portions.

The privacy window may further comprise an image processor. The video stream may include a central portion and a peripheral portion. The image processor may be operable to modify the video stream by increasing the ratio of an area of the central portion to an area of the peripheral portion to produce a modified video stream. The image processor may be operable to insert a virtual muntin between the central portion and the peripheral portion of the modified video stream.

In a second embodiment of a privacy window, the privacy window comprises a frame, a translucent portion, an electronic display, a camera, and an interconnection between the electronic display and the camera. The frame defines a perimeter of the privacy window and a plane of the privacy window. The plane has a first surface and a second surface opposite from the first surface. The frame defines an area of the privacy window. The translucent portion may be disposed within a first portion of the area. The electronic display may be disposed within a second portion of the area. The electronic display includes a display surface and a permanently opaque rear surface. The display surface may be substantially parallel to the plane and facing a first direction substantially perpendicular to the plane. The electronic display is operable to display video on the display surface. The display surface of the electronic display is visible from a first side of the privacy window and not visible from a second side of the privacy window. The first side of the privacy window is opposite from the second side of the privacy window. The camera may be operable to capture a video stream. The camera may be disposed facing a second direction substantially opposite from the first direction. The interconnection may be operable to enable the electronic display to display at least a portion of the video stream. The translucent portion and the electronic display may be disposed such that a first observer disposed on the second side of the privacy window is substantially unable to observe details through the privacy window.

Appropriate aspects of the first embodiment discussed above may also be incorporated into the present second embodiment.

In an aspect of the second embodiment, the first observer may be substantially unable to observe details through the privacy window when the privacy window is in a zero power state. The translucent portion and the electronic display may be disposed such that a second observer disposed on the first side of the privacy window is substantially unable to observe details through the privacy window other than by observing the video stream on the display surface.

The privacy window may be operable to simultaneously: provide light from the second side to the first side through the translucent portion; provide the video stream on the display surface; and prevent the first observer from substantially observing details of the first side through the privacy window.

In another embodiment, a kit for transforming a window into a privacy window is provided. The kit comprises an electronic display, a camera, an interconnection, and a mounting apparatus. The electronic display may be operable to display video on a display surface of the electronic display. The electronic display defines a front side and a rear side and the display surface faces the front side of the electronic display. The camera may be operable to capture a video stream. The interconnection may be operable to interconnect the electronic display and the camera and enable the electronic display to display at least a portion of the video stream. The mounting apparatus may be configured to mount the electronic display and the camera relative to each other such that the camera is disposed on the back side of the electronic display and pointing in a substantially opposite direction from the display surface. The mounting apparatus may be configured to mount to, and position the electronic display and camera within, a window frame.

The kit may further include a translucent material configured to attach to glass. Such translucent material may be a translucent film. The kit may further include an opaque material configured to attach to glass.

In an embodiment of a privacy door, the privacy door comprises a door, a translucent portion, an electronic display, a camera, and an interconnection between the electronic display and the camera. The door has a door perimeter and defines a plane of the privacy door. The plane has a first surface and a second surface opposite from the first surface. The door defines a door area within the plane. The translucent portion may be disposed within a first portion of the door area. The electronic display may be disposed within a second portion of the door area. The electronic display may include a display surface and a permanently opaque rear surface. The display surface of the electronic display may be substantially parallel to the plane and facing a first direction substantially perpendicular to the plane. The electronic display may be operable to display video on the display surface. The display surface may be visible from a first side of the privacy door, and the display surface may not be visible from a second side of the privacy door. The first side of the privacy door is opposite from the second side of the privacy door. The camera may be operable to capture a video stream. The camera may be disposed facing a second direction substantially opposite from the first direction. The interconnection may enable the electronic display to display at least a portion of the video stream. The translucent portion and the electronic display may be disposed such that a first observer disposed on the second side of the privacy door is substantially unable to observe details through the privacy door. Appropriate aspects of the privacy window embodiment discussed above may also be incorporated into the present privacy door embodiment.

In an aspect of the privacy door embodiment, the first observer may be substantially unable to observe details through the privacy door when the privacy door is in a zero power state. The translucent portion and the electronic display may be disposed such that a second observer disposed on the first side of the privacy door is substantially unable to observe details through the privacy door other than by observing the video stream on the display surface.

The privacy door may be operable to simultaneously: provide light from the second side to the first side through the translucent portion; provide the video stream on the display surface; and prevent the first observer from substantially observing details of the first side through the privacy door.

In another embodiment, a method for providing privacy through a window of a room comprises: capturing a video stream of an area outside of the window, wherein the area would be visible from the room through the window if the window had a portion void of visual impediment; displaying the video stream within the window, wherein the video stream is visible to an observer within the room and not visible to an observer outside of the room and proximate to the window; distorting a view of the room through the window such that no details of the room are visible through the window; and passing light from outside of the room into the room through the window. In the method, the capturing step, the displaying step, the distorting step, and the passing step all occur substantially simultaneously.

In an aspect of the present method, the method may further comprise recording an audio stream of sound proximate to and outside of the room and reproducing the audio stream within the room. The recording step, the reproducing step, and the displaying step may all occur substantially simultaneously.

In an aspect of the present method, the method may further comprise projecting light from the window toward the area outside of the window. The projecting step and the capturing step may occur substantially simultaneously. The projecting light step may include projecting visible and/or infrared light.

In an aspect of the present method, the method may further comprise sensing a first light level of the area outside of the window, sensing a second light level within the room, and controlling a brightness of the displaying of the video stream based on the first light and second light levels.

In an aspect of the present method, the method may further comprise sensing an occupancy status of the room and initiating the displaying step based on the occupancy status.

In an aspect of the present method, the method may further comprise dividing the video stream into a central portion and a peripheral portion, and modifying the video stream by increasing the ratio of an area of the central portion to an area of the peripheral portion.

In an aspect of the present method, the method may further comprise inserting a virtual muntin into the video stream.

In another embodiment of a privacy window, the privacy window comprises an opening in a wall, an electrochromic portion, an electronic display, a camera, and an interconnection between the electronic display and the camera. The opening in the wall may be disposed between an interior of the room and an exterior of the room. The electrochromic portion may be disposed within a first portion of the opening and may be operable to be in a translucent state. The electronic display may be disposed within a second portion of the opening. The electronic display includes a display surface and a permanently opaque rear surface. The display surface faces the interior of the room. The electronic display is operable to display video on the display surface. The camera may be positioned such that it is operable to capture a video stream of a view of the exterior of the room. Such a view would be at least partially visible to a first observer within the room if a portion of the electrochromic portion were transparent. The interconnection between the electronic display and the camera is operable to enable the electronic display to display at least a portion of the video stream. When the electrochromic portion is in the translucent state, the electrochromic portion and the electronic display may be disposed such that a second observer outside of the room is substantially unable to observe details within the room through the privacy window.

In another embodiment of a privacy window, the privacy window comprises a frame, an electrochromic portion, an electronic display, a camera, and an interconnection between the electronic display and the camera. The frame defines a perimeter of the privacy window and a plane of the privacy window. The plane has a first surface and a second surface opposite from the first surface. The frame defines an area of the privacy window. The electrochromic portion may be disposed within a first portion of the area. The electrochromic portion may be operable to be in a translucent state. The electronic display may be disposed within a second portion of the area. The electronic display includes a display surface and a permanently opaque rear surface. The display surface may be substantially parallel to the plane and facing a first direction substantially perpendicular to the plane. The electronic display is operable to display video on the display surface. The display surface of the electronic display is visible from a first side of the privacy window and not visible from a second side of the privacy window. The first side of the privacy window is opposite from the second side of the privacy window.

The camera may be operable to capture a video stream. The camera may be disposed facing a second direction substantially opposite from the first direction. The interconnection may be operable to enable the electronic display to display at least a portion of the video stream. When the electrochromic portion is in the translucent state, the electrochromic portion and the electronic display may be disposed such that a first observer disposed on the second side of the privacy window is substantially unable to observe details through the privacy window.

Additional aspects and advantages of the present invention will become apparent to one skilled in the art upon consideration of the further description that follows. It should be understood that the detailed description and specific examples are intended for purposes of illustration only and are not intended to limit the scope of the invention. Furthermore, any of the above embodiments, aspects and/or features may be combined with any other of the above embodiments, aspects and/or features where appropriate.

### BRIEF DESCRIPTION OF THE DRAWINGS

FIG. 1 is an isometric view of a privacy window positioned in an opening of a wall of a room.

FIG. 2 is an isometric view of the privacy window of FIG. 1 as viewed from the exterior of the room.

FIG. 3 is an isometric view of an alternative arrangement of the privacy window of FIGS. 1 and 2.

FIG. 4 is an isometric view of an alternative arrangement of the privacy window of FIGS. 1 and 2.

FIG. 5 is an isometric view of an alternative arrangement of the privacy window of FIGS. 1 and 2 as seen from an exterior of a room.

FIG. 6 is a partial sectional view of the privacy window of FIGS. 1 and 2.

FIG. 7 is an isometric view of an alternative arrangement of a privacy window with an electronic display that consists of three discrete sections.

FIG. 8 is a view of an electronic display of a privacy window showing an image.

FIG. 9 is a view of the electronic display of FIG. 8 divided into five sections.

FIG. 10 is a view of the electronic display of FIG. 9 with the image modified.

FIG. 11 is an isometric view of an embodiment of a privacy window that is a standalone window capable of being installed into an opening of a wall.

FIG. 12 illustrates a kit that can be used to transform a typical transparent window into a privacy window.

FIG. 13 is an isometric view of a privacy door.

FIG. 14 is a flowchart of a method for providing privacy through a window of a room.

### DETAILED DESCRIPTION OF THE INVENTION

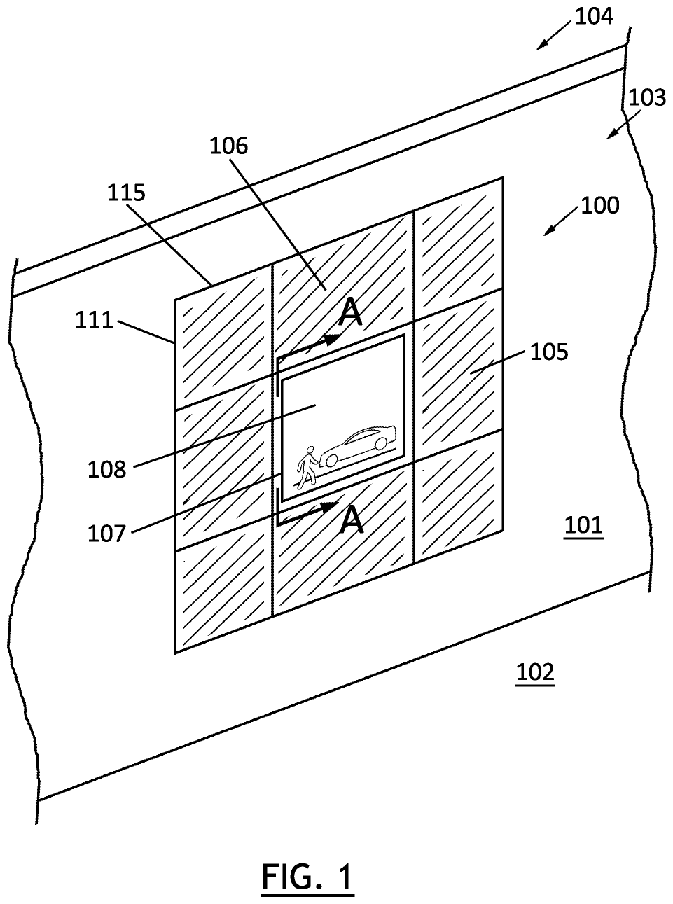

FIG. 1 is an illustration of an embodiment of a privacy window 100 positioned in an opening 111 of a wall 101 of a room 102. The wall 101 separates an interior 103 of the room 102 from an exterior 104 of the room 102. The exterior 104 may, for example, be the outside of a building and the room 102 may be part of the interior of a building. In another example, the exterior 104 may be a separate room of a building that also includes the room 102.

The privacy window 100 comprises a translucent portion 105. As used herein, “translucent” refers to a material that allows light to pass therethrough, but through which details of the opposite side of the material are not visible. Common examples of translucent materials include, but are not limited to, frosted glass, stained glass, etched glass, “Rain” glass, and glass blocks. Additionally, the translucent material may be similarly configured as discussed, but the base material may be any appropriate material capable of passing light therethrough, such as acrylic (e.g., Plexiglas®) and polycarbonate (e.g., Lexan®). Additionally, the translucent material may comprise a translucent layer attached to a clear base material, such as translucent polymer film attached to glass. Alternatively, the translucent layer may be applied by, for example, spraying, rolling or brushing.

The translucent portion 105 may be permanently translucent, such as for example, frosted glass, or, in an alternative embodiment, the translucent portion 105 may be at least partially replaced by an electrochromic portion or other variable transparency technology (e.g., polymer-dispersed liquid-crystal). As used herein, “electrochromic portion” is used to describe a portion whose opacity may be changed by the application of electricity to the portion. The opacity may be changed from a relatively transparent state to a translucent state. Such an electrochromic portion may be constructed in any appropriate manner including for example electrochromic glass or an electrochromic film applied to a transparent base material (e.g., glass).

The translucent portion 105 may be configured such that no portion of the translucent portion 105 may be openable. Such an arrangement may be beneficial in that it may prevent airflow or other material from passing through the privacy window 100. This may be beneficial to security and/or environmental control. The translucent portion 105 may include an opening portion 106 which can be opened to allow airflow through the privacy window 100. The opening portion 106 as shown is a hopper window that opens from the top. Such a window allows airflow and maintains privacy in that an observer positioned in the exterior 104 of the room 102 would not be able to easily observe the interior 103 of the room 102. The opening portion 106 alternatively may be configured to open in any appropriate manner, such as sliding windows and casement windows. The privacy window 100 may include multiple opening portions. The opening configuration may be configured such that when the window is open to allow airflow, the elements are arranged such that there is limited or no direct line of sight from the exterior 104 to the interior 103 to maintain privacy. Alternatively, the opening portion 106 may be configured such that when the window is open to allow airflow, there is a direct line of sight from the interior 103 to the exterior 104 to allow observers to see through the privacy window 100.

The privacy window 100 comprises an electronic display 107 that includes a display surface 108 that is operable to display color images for observation by observers within the interior 103 of the room 102. The electronic display 107 may be of any appropriate type such as, for example, LED, OLED, LCD, plasma, or CRT. For example, the electronic display 107 may be an Ultra High definition (UHD) monitor or television with a resolution of about 3,840 pixels by 2,160 pixels (commonly known as “4K”). The electronic display 107 may incorporate In-Plane Switching (IPS) technology which provides for relatively high viewing angles, which enables the displayed image to be visible from more locations within the room 102. The electronic display 107 may be capable of receiving video information using any appropriate technology, such as, for example, wireless communications, an HDMI interface, component video, DVI, USB, or a DisplayPort.

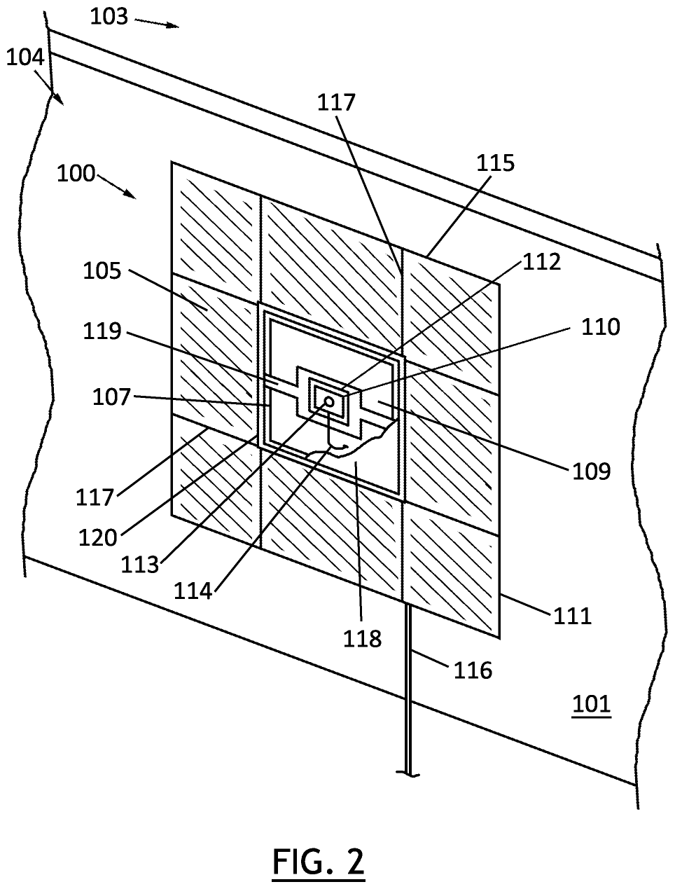

FIG. 2 is an illustration of the privacy window 100 as viewed from the exterior 104 of the room 102. A rear surface 109 of the display may be oriented such that the rear surface 109 faces the exterior 104 of the room. The rear surface 109 may be permanently opaque, such as the typical black housing on most televisions and monitors. In the embodiment shown in FIGS. 1 and 2, no portion of video displayed on the display surface 108 is visible from the exterior 104 of the room 102 through the privacy window 100.

The privacy window 100 comprises a camera 110 operable to capture a video stream. The camera 110 may be disposed within the opening 111. The camera 110 may be positioned behind the electronic display 107 and oriented such that it is operable to capture a video stream of at least a portion of the exterior 104. Alternatively, the camera 110 may be positioned along a perimeter of the privacy window 100 or in the area of the translucent portion 105. The camera 110 may be oriented such that it points in a direction substantially perpendicular to, and pointing away from, the wall 101. In this regard, the camera 110 may be positioned to capture a video stream of the exterior 104 that would be at least partially visible through the privacy window 100 if the privacy window 100 were at least partially transparent.

The camera 110 may be of any appropriate construction and quality level capable of capturing a video stream. The camera 110 may be capable of capturing a video stream with a level of quality and format that enable the video stream to be played on the electronic display 107. For example, the camera 110 may be capable of capturing UHD video and outputting such video in real time or near real time over an HDMI or DisplayPort output.

The camera 110 may be mounted on an adjustable mount 112 such that the direction which the camera 110 is pointing may be adjusted. Such adjustment may be performed manually, or the adjustable mount 112 may be motorized to allow for remote control of the direction (e.g., pan and tilt) which the camera 110 is pointing. Alternatively, the camera 110 may be affixed to the privacy window 100 in such a manner that the camera 110 and the direction which it is pointing are fixed relative to the electronic display 107.

The camera 110 includes a lens 113. The lens 113 may of a fixed focal length or the lens may be a zoom lens. Where the lens 113 is a zoom lens, the lens 113 may be manual or the lens 113 may be motorized to allow for remote control of the focal length.

The lens 113 may encompass any appropriate focal length. For example, the lens 113 may be a wide angle lens to enable the camera 110 to capture a video stream of what would be visible through the privacy window 100 of the exterior 104 by an observer within the room 102. Such a lens may have a field of view of 100° to 180°. In particular, such a lens may have a field of view in the range 120° to 155°. A wide angle view allows an observer inside the room 102 to observe a greater field of view of the exterior 104.

The camera 110 may be capable of adjusting to differing light levels that may be present in the exterior 104. For example, where the exterior 104 is the exterior of a building, the camera 110 may be capable of adjusting itself to capture video streams in bright sunlight, nighttime darkness, and any light level between. The camera 110 may also include the ability to generate the video stream using infrared light (“night vision”).

A lens shade may be mounted to the camera 110 to reduce glare from light sources not directly within the field of view of the camera 110.

The electronic display 107 and camera 110 may be mounted to a support member 119 that may fix the electronic display 107 and camera 110 relative to the translucent portion 105.

The privacy window 100 comprises an interconnection 114 connecting the electronic display 107 to the camera 110. The interconnection 114 enables a video stream captured by the camera 110 to be delivered to the electronic display 107 for real-time or near real-time display. The interconnection 114 may be a cable, such as an

HDMI cable or DisplayPort cable. In an alternative embodiment, the interconnection 114 may be a wireless connection, such as Wi-Fi or Bluetooth, and the camera 110 and electronic display 107 may include elements to enable such a wireless interconnection.

The privacy window 100 comprises a mounting structure to fix the location of the electronic display 107 and camera 110 within the opening 111. The mounting structure may provide mounting locations for the camera 110 and electronic display 107 and also interconnect to the translucent portion 105 and/or a frame 115 of the privacy window 100. The privacy window 100 may also comprise a power cord 116 to deliver electrical power to the camera 110 and electronic display 107.

The privacy window 100 may also include a support frame 120 or similar supporting member around the electronic display 107 to position the electronic display 107. The support frame 120 may form an opening within the privacy window 100 to allow space for the electronic display 107. The support frame 120 may be configured to fill any gap that may exist between the edge of the electronic display 107 and the translucent portion 105 such that an observer in the exterior 104 is not able to look into the interior 103 through a gap between the electronic display 107 and translucent portion 105.

The privacy window 100 may also include a remote control capable of controlling the camera 100 and/or the electronic display 107. Such a remote may be in the form of a stand-alone device or it may be a computer, phone, tablet or other electronic device capable of running software to control aspects of the privacy window 100. Such control may include power state of the electronic display 107 and/or camera 110 and/or other settings for the electronic display 107 and/or camera 110.

The electronic display 107 may include an interface to receive information from sources other than the camera 110 such that the electronic display 107 may, for example, be used as a television or computer monitor.

The privacy window 100 may also include muntins 117. Such muntins 117 may be disposed between panes of the translucent portion 105, as well as between the translucent portion 105 and the electronic display 107. The muntins 117 may also serve as a conduit for the placement of the power cord 116 or other wiring connected to the electronic display 107 and/or camera 110.

The electronic display 107 and translucent portion 105 may be disposed such that an observer in the exterior 104 is not able to look into the interior 103 through the privacy window 100. Additionally, the electronic display 107 and translucent portion 105 may be disposed such that an observer in the interior 103 is not able to look into the exterior 104 through the privacy window 100 other than by observing the video stream on the electronic display 107.

The privacy window 100 may include a panel 118 (partially shown) positioned behind the electronic display 107. The panel 118 may provide protection to the camera 110 and the rear of the electronic display 107. Alternatively, the panel 118 may have a hole therethrough in which at least a portion of the camera 110 may be positioned. The panel 118 may be made of a material the same as or similar to the translucent portion 105 to present a uniform appearance to an observer looking at the privacy window 100 from the exterior 104.

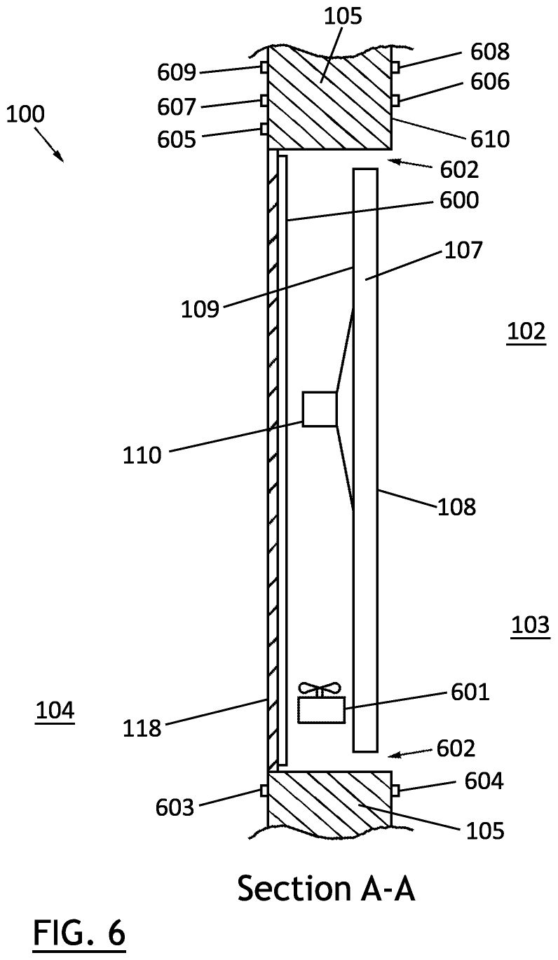

Section A-A indicated in FIG. 1 is illustrated in FIG. 6. The privacy window 100 may include a layer 600 (not shown in FIGS. 1 and 2) positioned between the panel 118 and the electronic display 107 that is opaque and/or reflective. The layer 600 may serve to inhibit energy (e.g., direct sunlight) from directly striking the rear surface 109 of the electronic display 100 and camera 110, thus helping to reduce temperature gain of the electronic display 107 and camera 110 due to energy incident on the privacy window 100. The layer 600 may have a hole therethrough in which at least a portion of the camera 110 may be positioned. The layer 600 may be a film attached to the backside of the panel 118 or it may be a separate element.

The privacy window 100 is operable to provide three distinct benefits simultaneously and under all lighting conditions:

allow light to pass through the translucent portion 105;

allow an observer in the interior 103 to observe the exterior 104 as captured by the camera 110 and displayed on the electronic display 107; and prevent an observer in the exterior 104 from observing the interior 103 through the privacy window 100.

The privacy window 100 thus provides a unique set of benefits. For example, where the privacy window 100 is disposed in an exterior wall of a building, the privacy window 100 can allow natural light to pass through the translucent portion 105 into the building, while simultaneously allowing occupants of the building to observe the outside of the building on the electronic display 107 as if the electronic display 107 were a transparent window, while also simultaneously preventing an observer from seeing into the building, even if that observer actively tries to look into the building. This is true for all lighting conditions. Indeed, where camera 110 is operable to generate a video stream in low light conditions, the ability of occupants of the room 102 to see the exterior 104 as shown on the electronic display 107 may be enhanced over what would be possible if the privacy window 100 were simply a typical transparent window.

Known window privacy systems, such as reflective coatings, generally inhibit the ability of outside observers from seeing into a building when the light level on the exterior of a building is significantly greater than the light level on the interior of the building. Nonetheless, an outside observer can move closer to the window and still see through the film by cupping their hands around their eyes and against the glass. Moreover, as the exterior light fades, the privacy provided by such coatings fades and eventually, the privacy affect is reversed. That is, when the interior light level is greater than the exterior light level, outside observers can easily see the interior of the room, while occupants of the room cannot see out of the window through the reflective film. In such a circumstance, blinds or shades are generally used to block all vision through such windows if privacy is desired.

The privacy window 100 may be configured such that a loss of power to the privacy window 100 does not result in a loss of security. That is, when there is no power present, either from a power source being removed or from batteries being drained, an observer on the exterior 104 would not be able to observe any details of the interior 103 through the privacy window 100.

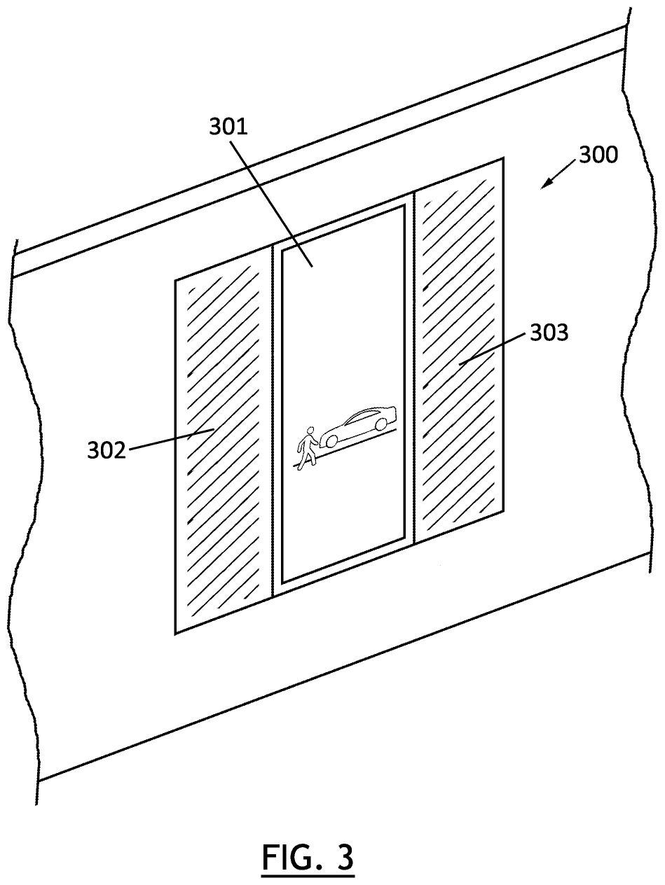

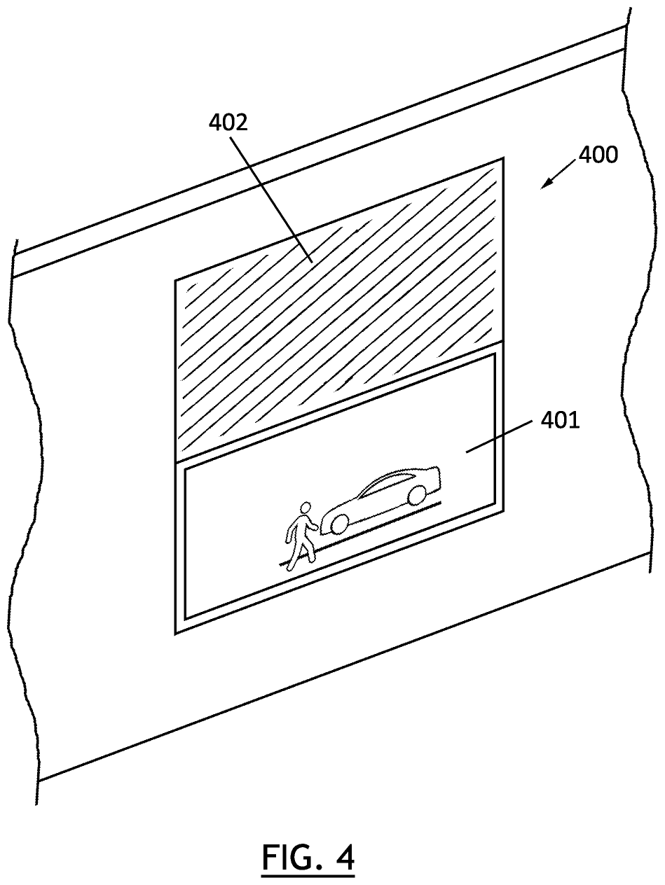

As shown in FIGS. 1 and 2, the electronic display 107 may be positioned such that the translucent portion 105 surrounds the electronic display 107. FIGS. 3 and 4 show alternative arrangements to the privacy window of FIGS. 1 and 2. FIG. 3 illustrates an arrangement of a privacy window 300 where an electronic display 301 occupies a central panel and translucent portions 302, 303 occupy panels on both sides of the electronic display 301. FIG. 4 illustrates an arrangement of a privacy window 400 where an electronic display 401 occupies a bottom portion and a translucent portion 402 occupies a top portion of the privacy window 400. Any other appropriate arrangement of electronic displays and translucent portions may be used.

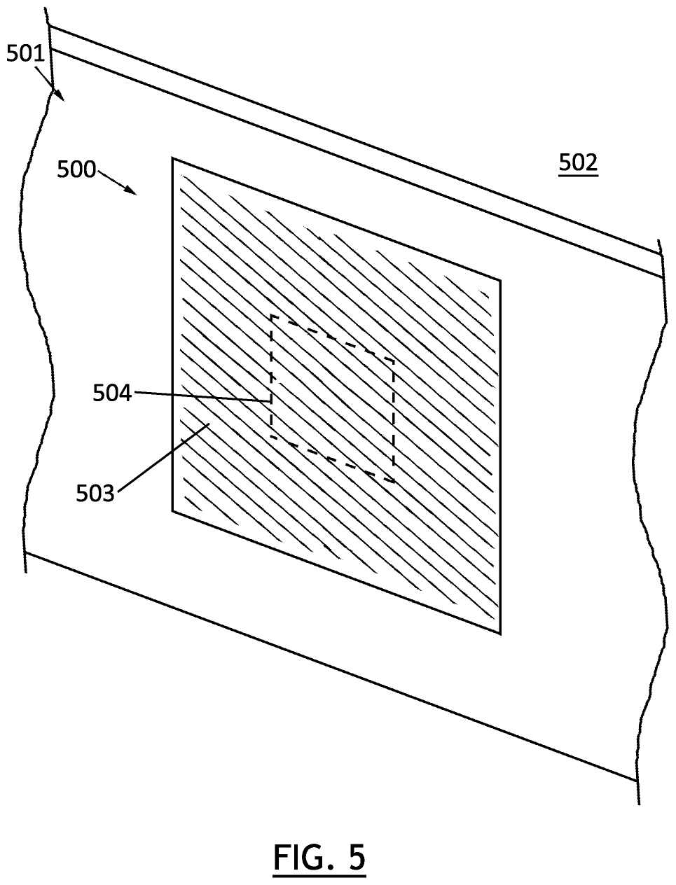

FIG. 5 illustrates an alternative arrangement of a privacy window 500 as seen from an exterior 501 of a room 502. In this embodiment, the exterior side of the privacy window 500 is covered in glass 503 such that the rear surface of an electronic display 504 is substantially not visible to observers disposed in the exterior 501. In such an arrangement, the material used to create the translucent portion of the privacy window 500 may also be positioned behind the electronic display 504 such that the privacy window 500 has a uniform appearance across its external surface. As illustrated in FIG. 6, the privacy window 100 may include one or more air movement apparatuses such as a fan 601 positioned to move air through the gap between the electronic display 107 and the panel 118. Such air movement may help to maintain a reduced temperature of the camera 110 and/or electronic display 107. Accordingly, there may be gaps 602 between the electronic display 107 and the translucent portion 105 to allow air to flow around the electronic display 107.

As illustrated in FIG. 6, the display surface 108 of the electronic display 107 may be recessed relative to a surface 610 of the translucent portion 105 facing the interior 103. Such an arrangement may aid in giving the display surface 108 the appearance of looking out of a window. Alternatively, the display surface 108 of the electronic display 107 could be flush with or extend beyond the surface 610 of the translucent portion 105 facing the interior 103.

The privacy window 100 may include at least one microphone 603 and at least one speaker 604. The microphone 603 may be positioned to capture sounds from the exterior 104. These sounds may then be reproduced by the speaker 604 positioned in the interior 103, thus providing occupants of the room 102 with additional sensory information related to the exterior 104.

The privacy window 100 may include at least one light source 605. The light source 605 may be configured to project light from the privacy window 100 into the exterior 104. The light source 605 may be operable to project visible and/or infrared light to enhance image quality of the electronic display 107. The light source 605 may be controlled in any appropriate manner, such as by a timer, a user, or in reaction to a sensor input, such as a motion sensor. Where the light source 605 includes the ability to project infrared light, the privacy window 100 may be operable to provide images of the exterior 104 in low light conditions.

The privacy window 100 may include an interior light level sensor 606. The privacy window 100 may include an exterior light level sensor 607. The output from the interior light level sensor 606 and/or exterior light level sensor 607 may be used to adjust the brightness of the electronic display 107 to enhance the ability of an observer in the room 102 to view the video stream on the electronic display 107 and/or to enhance the effect of the electronic display 107 appearing to be a typical transparent window. Such adjustment may be performed automatically by the privacy window 100.

The privacy window 100 may include an interior occupancy sensor 608. The privacy window 100 may include an exterior occupancy sensor 609. The interior occupancy sensor 608 may be used to determine the presence of an occupant within the room 102. Such information may be used to control the power state of various components of the privacy window 100. For example, if the interior occupancy sensor 608 does not detect the presence of a person in the room 102 for a predetermined amount of time, the privacy window 100 may turn off the electronic display 107, thus saving power and extending the life of the electronic display 107. When the interior occupancy sensor 608 detects an occupant while the electronic display 107 is off, the privacy window 100 may turn on the electronic display 107.

The external occupancy sensor 609 may be used to determine the presence of a person in the exterior 104 and proximate to the privacy window 100. Such information may be used when the electronic display 107 is powered down, for example by a user, but where the user would like to be alerted if there is a person proximate to the privacy window 100. In such a scenario, the privacy window 100 may alert an occupant by powering up the electronic display 107 and displaying the video stream. Such an alert may be accompanied by an audio signal. Alternatively, the function of the external occupancy sensor 609 may be performed by the camera 110.

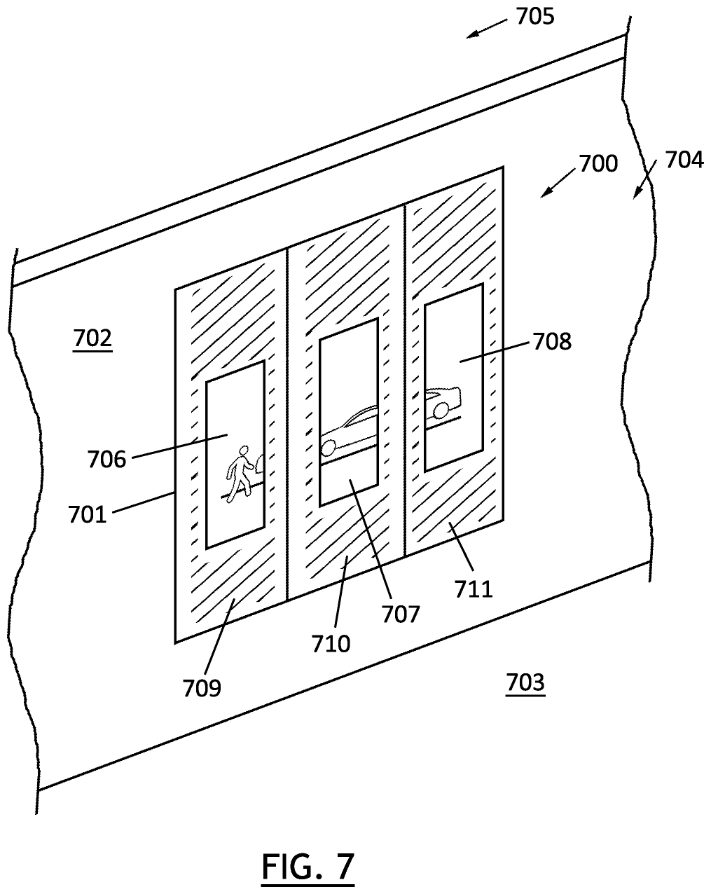

FIG. 7 is an illustration of an additional embodiment of a privacy window 700 positioned in an opening 701 of a wall 702 of a room 703. The wall 702 separates an interior 704 of the room 703 from an exterior 705 of the room 703. The configuration and components of the privacy window 700 is similar to that of privacy window 100, with the exception that the privacy window 700 comprises multiple electronic displays 706, 707, 708. In privacy window 700, each of the electronic displays 706, 707, 708 is surrounded by translucent portions 709, 710, 711, respectively. The electronic displays 706, 707, 708 may display images captured by a single camera where the video stream from the camera is divided into three sections. The privacy window 700 may be configured such that no portion of the video stream appears on more than one of the electronic displays 706, 707, 708. Alternatively, the privacy window 700 may be configured such that there is an overlap and some of the video stream appears on more than one of the electronic displays 706, 707, 708. Alternatively, each of the electronic displays 706, 707, 708 may be interconnected to a unique camera.

As with translucent portion 105, the translucent portions 302, 303, 402, 709, 710, 711 may be permanently translucent, such as for example, frosted glass, or, in an alternative embodiment, they may be at least partially replaced by an electrochromic portion.

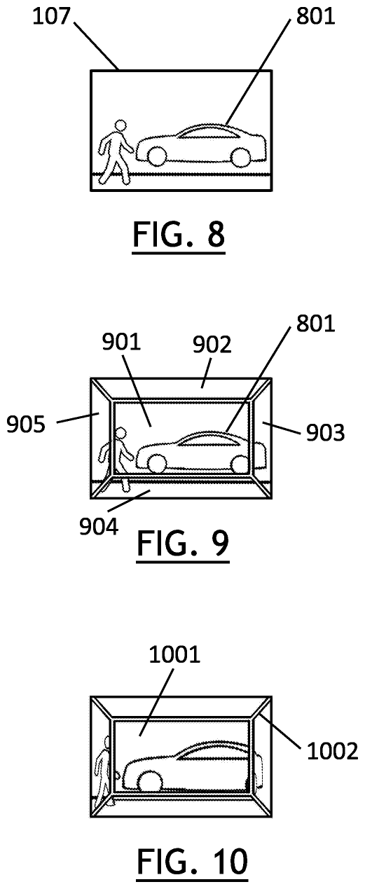

FIG. 8 is a view of the electronic display 107 of the privacy window 100. As illustrated, the electronic display 107 may display an image 801 of the exterior 104 of the room 102. As discussed, such an image 801 may be a wide angle image. While wide angle images may communicate a great deal of information, they also may be perceived to render the center area of the image smaller than desired. Accordingly, the privacy window 100 may perform image processing to alter the video stream as follows.

FIG. 9 shows the image 801 divided into five sections: a center section 901 and four edge sections 902, 903, 904, 905. FIG. 10 shows the image 801 transformed into a modified image 1001 where the size of the center section 901 has been enlarged and the four edge sections 902, 903, 904, 905 have been shrunk relative to their sizes in FIG. 9.

Additionally, virtual muntins 1002 have been inserted into the image over the areas where the different sections meet. A virtual muntin is a digital element inserted into a video stream to simulate the appearance of a muntin on a window and has the effect of dividing the video stream into sections. A virtual muntin may be used to cover an interface between two different sections of a video stream. The effect of this manipulation is that more information (i.e., it is larger) is communicated to the observer about the center of the image, while information along the edges is maintained. Thus, for example, where the privacy window 100 was installed in a wall along a city street, an observer of the electronic display 107 would be able to see the center area (such as passersby on the sidewalk and traffic in the street) of the image in detail, while simultaneously seeing the edges (e.g., to see people leaning against the wall to either side of the privacy window 100).

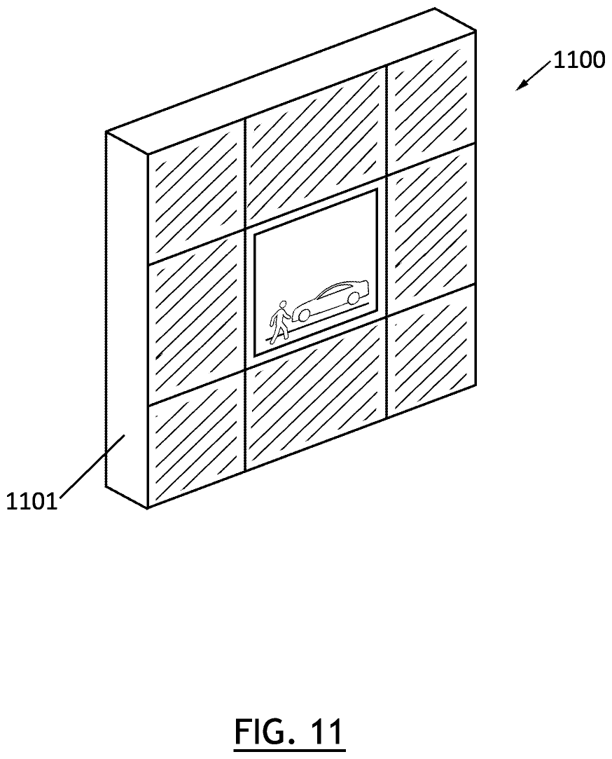

FIG. 11 is an illustration of an embodiment of a privacy window 1100 that, as opposed to the privacy window 100 positioned within the opening 111 of wall 101, is a standalone window capable of being installed into an opening of a wall. As such, the privacy window 1100 includes a frame 1101 within which all of the components of the privacy window 1100 may be disposed. The frame 1100 is disposed around a perimeter of the privacy window 1100.

All of the features of the privacy window 100 may be incorporated into the privacy window 1100. The privacy window 1100 may be fabricated remotely from its ultimate installation location, shipped to that location, and installed in a similar fashion as typical windows, with an exception being that the privacy window 1100 may need to be interconnected to a power source.

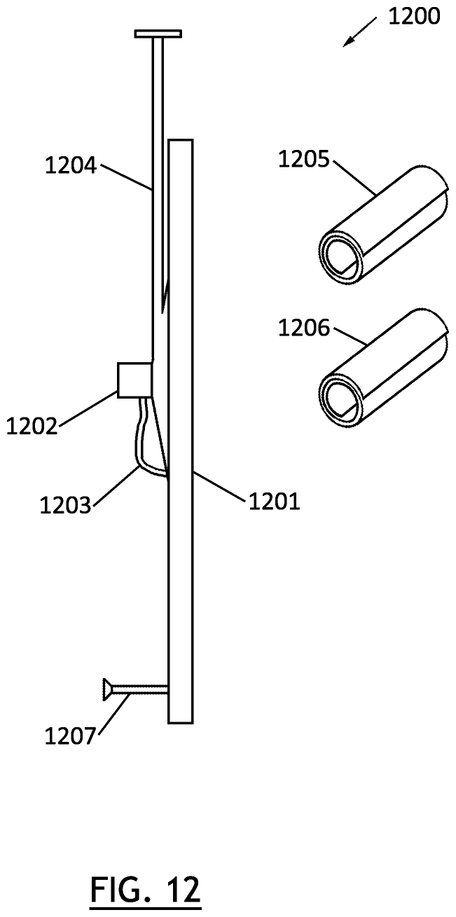

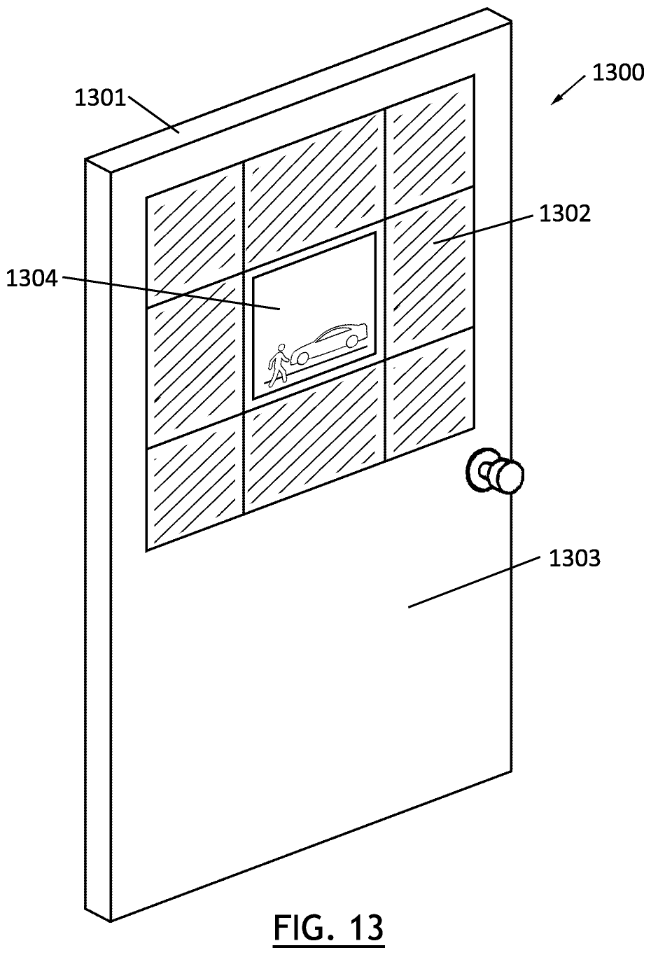

FIG. 12 is an illustration of kit 1200 that can be used to transform a typical transparent window into a privacy window. The kit 1200 comprises an electronic display 1201, a camera 1202, an interconnection 1203 and a mounting apparatus 1204. These components (shown from a side view) may be pre-assembled in the kit 1200 as shown or provided separately. Once installed, the electronic display 1201, the camera 1202, and the interconnection 1203 may provide the same functionality as the corresponding elements of the privacy window 100 described above.

The mounting apparatus 1204 provides for the mounting of the camera 1202 and the electronic display 1201 relative to each other. The mounting apparatus 1204 also provides for the mounting of the camera 1202 and the electronic display 1201 to the frame of an existing window. As shown in FIG. 12, the mounting apparatus 1204 may be configured to attach to the underside of the top of a window frame. Thus allowing the camera 1202 and the electronic display 1201 to hang from the window frame and be positioned within the window opening. Alternatively, the mounting apparatus 1204 may include components to attach to any combination of the top, sides or bottom of the window frame or area of wall, ceiling, or floor proximate to the window frame.

The kit 1200 may include a translucent material that may be attached to the window to create a translucent portion. One such material is a roll of translucent material 1205 that may be unrolled and adhered to the window to make a portion of the window translucent. The kit 1200 may also include an opaque material that may be attached to the window to create an opaque portion in the area of the window proximate to the electronic display 1201. Such an opaque portion may reduce solar energy incident on the camera 1202 and/or electronic display 1201. Such an opaque portion may also prevent an outside observer from seeing the rear surface of the electronic display 1201. One such opaque material is a roll of opaque material 1206 that may be unrolled and adhered to the window to make a portion of the window opaque. A window may be cut into the opaque material 1206 to allow the camera 1202 to capture a video stream of the area outside of the window. Other examples of opaque and transparent materials that may be included in the kit 1200 for making portions of the window opaque or translucent include sprays, tiles, plastic sheets and glass. The kit 1200 may further include stabilizing hardware 1207 that may be positioned against the glass of the window to prevent movement of the electronic display 1201 and camera 1202 relative to the window. The stabilizing hardware 1207 may be adjustable length posts that may help to stabilize and position the electronic display 1201 and camera 1202. The stabilizing hardware 1207 may include suction cups or soft tips where the stabilizing hardware 1207 contacts the window. The kit 1200 may also include any appropriate feature, such as sensors and lights, discussed above with reference to the privacy window 100.

By correctly positioning the electronic display 1201 and translucent material 1205, a window may be transformed into a privacy window operable to provide three distinct benefits simultaneously and under all lighting conditions:

allow light to pass through the translucent portion;

allow an observer to observe the area exterior of the window as captured by the camera 1202 and displayed on the electronic display 1201; and

prevent an observer in the area exterior of the window from observing the interior through the privacy window.

As with translucent portion 105, the translucent material 1205 may be permanently translucent, or in an alternative embodiment, the translucent material 1205 may be at least partially replaced by an electrochromic film.

FIG. 13 is an illustration of an embodiment of a privacy door 1300 that comprises a door 1301 and a privacy window 1302 disposed in the privacy door 1300.

All of the features of the privacy window 100 may be incorporated into the privacy window 1302. In FIG. 13, the side of the privacy door 1300 that faces the interior of a room is shown. As illustrated, the privacy window 1302 may occupy a portion of the privacy door 1300, with the remaining non-window portion 1303 of the privacy door 1300 being made of opaque material, such as traditional door materials (e.g., wood, fiberglass, metal). Alternatively, the privacy window 1302 may occupy the entirety of the privacy door 1300, resulting in substantially the entire privacy door 1300 (apart from an electronic display 1304) being made of translucent material.

The privacy door 1300 may be used wherever a traditional door may be used. The privacy door 1300 may be used as an exterior door, and the electronic display 1304 may display a video stream of the area directly outside of the privacy door 1300. In this regard, the privacy door 1300 may be used as a security device allowing an observer to observe what is on the other side of the privacy door 1300 before opening the privacy door 1300. As such, a camera of the privacy door 1300 may incorporate a lens with a wide field of view, such as 180°, so that an observer can see an entirety of the space directly on the other side of the privacy door 1300.

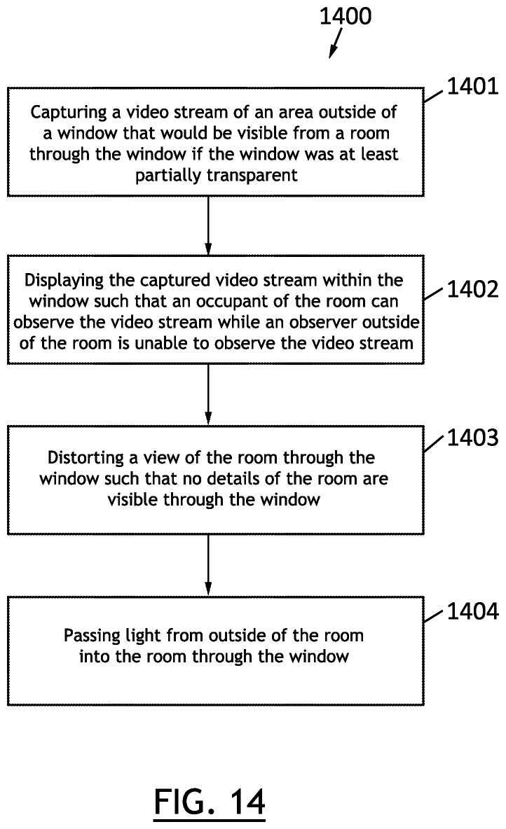

FIG. 14 is a flowchart 1400 of a method for providing privacy through a window of a room. The first step 1401 includes capturing a video stream of an area outside of a window that would be visible from a room through the window if the window was at least partially transparent. The second step 1402 includes displaying the captured video stream within the window such that an occupant of the room can observe the video stream while an observer outside of the room is unable to observe the video stream. The third step 1403 includes distorting a view of the room through the window such that no details of the room are visible through the window. The fourth step 1404 includes passing light from outside of the room into the room through the window. The method requires that each of the steps 1401, 1402, 1403, 1404 occur simultaneously.

The method may further include receiving an audio stream from the outside of the room and reproducing the audio stream within the room. The method may further include projecting light from the window toward the area outside of the window. The method may further include sensing light levels on both sides of the window and adjusting the output of the displayed video stream accordingly. The method may further include sensing the presence of individuals outside of the window and displaying the video stream in response. The method may further include sensing the presence of individuals inside the room and displaying the video stream in response. The method may further include dividing the video stream into a central portion and peripheral portions and modifying the video stream by increasing the ratio of the area of the central portion to the area of the peripheral portion. The method may further include inserting a virtual muntin between the central portion and the peripheral portion of the modified video stream.

The above-described embodiments of privacy windows may be used in a variety of applications. For example, such privacy windows and/or doors may be used in residential buildings where there is a significant amount of traffic (e.g., foot traffic) past a window, such as a townhome in an urban area with street level windows or a condominium with a balcony with entrances and windows. In such applications, a traditional window may cause a resident to choose a sub-optimal window configuration such as: translucent glass which provides privacy but prevents observation of the area outside the window; reflective film which provides some privacy under certain conditions but would require blinds or shades to provide privacy when the reflective film is inadequate; or the resident would forego privacy and have a traditional glass window with blinds or shades for when privacy is needed. With the privacy windows and doors described herein, the resident would enjoy (simultaneously and under all lighting conditions) complete privacy, natural light, and the ability to observe the environment on the other side of the privacy window or door.

Another application is commercial buildings where there is a significant amount of traffic past a window, such as an office or cubicle with a street level window. The privacy windows and doors described herein would provide the benefits as discussed above with relation to residential applications. Additionally, the portion of the privacy window facing the exterior of the building that is occupied by the electronic display (that faces the interior of the building) may be used as informational space for observers outside of the building. For example, advertising or other information, in the form of printed material (e.g., a poster) or another electronic display facing the exterior of the building, could be present without infringing on the translucent area of the privacy window.

Another application is where a high level of security is required. For example, a security station may require the ability to observe surroundings while preventing observers from seeing into the station. In such applications, the translucent portion may include bullet proof or ballistic resistant glass.

In an application of the privacy windows and doors described herein, the video stream may also be recorded by a video recording device. In this regard, the privacy windows and doors may be part of an electronic security system.

In addition to providing the ability to allow light to pass through the translucent portion and simultaneously prevent an observer from seeing through the privacy window or door, the electronic display of the privacy window or door may be used to present alternative information, such as entertainment (e.g., television programming, games) and security data (e.g., video feeds from other cameras), and computer output (e.g., used as a computer monitor). Such alternative information may be presented full screen or may be arranged in a picture-in-picture arrangement where the alternative information appears in a small window on the electronic display and the remainder of the display shows the video stream from the camera, or vice versa.

The foregoing written description of the invention enables one skilled in the art to make and use what is considered presently to be the best mode thereof. Additional variations, combinations, and equivalents of the specific embodiments, methods, and examples described herein will be apparent to those skilled in the art. Such modifications and extensions are intended to be within the scope of the present invention as defined by the claims that follow. The invention should therefore not be limited by the above described variations, embodiments, methods, and examples, but by all variations, embodiments and methods within the scope and spirit of the invention.

What is claimed is:

1. A privacy window comprising:
an opening in a wall of a room of a building, wherein said opening is disposed between an interior of said room and an exterior of said room;
a translucent portion disposed within a first portion of said opening;
an electronic display disposed within a second portion of said opening, wherein said electronic display comprises a display surface and a rear surface, wherein said rear surface is permanently opaque, wherein said display surface of said electronic display is disposed facing said interior of said room, wherein said electronic display is operable to display video on said display surface;
a camera positioned such that it is operable to capture a video stream of a view of said exterior of said room, wherein said view would be at least partially visible to a first observer within said room if a portion of said translucent portion were transparent; and
an interconnection between said electronic display and said camera operable to enable said electronic display to display at least a portion of said video stream, wherein said translucent portion and said electronic display are disposed such that a second observer outside of said room is substantially unable to observe details within said room through said privacy window.

2. The privacy window of claim 1, wherein at least a portion of said translucent portion is an electrochromic portion operable to be in a translucent state.

3. The privacy window of claim 1, wherein said translucent portion comprises at least one of privacy glass, glass block, frosted glass, stained glass, translucent polymer, and translucent film.

4. The privacy window of claim 1, wherein said first portion of said opening and said second portion of said opening together substantially make up an entirety of said opening.

5. The privacy window of claim 1, further comprising muntins disposed between said first portion of said opening and said second portion of said opening.

6. The privacy window of claim 1, wherein said second observer outside of said room is substantially unable to observe details within said room through said privacy window when said privacy window is in a zero power state.

7. The privacy window of claim 1, wherein said camera is positioned within a perimeter of said opening.

8. The privacy window of claim 1, wherein said privacy window is operable to simultaneously:
provide light from said exterior of said room to said interior of said room through said translucent portion;
provide said first observer said video stream of said view of said exterior of said room; and
prevent said second observer from substantially observing details within said room through said privacy window.

9. A privacy window comprising:
a frame, wherein said frame defines a perimeter of said privacy window, wherein said frame defines a plane of said privacy window, said plane having a first surface and a second surface opposite from said first surface, wherein said frame defines an area of said privacy window;
a translucent portion disposed within a first portion of said area;
an electronic display disposed within a second portion of said area, wherein said electronic display comprises a display surface and a rear surface, wherein said rear surface is permanently opaque, wherein said display surface of said electronic display is substantially parallel to said plane and facing a first direction substantially perpendicular to said plane, wherein said electronic display is operable to display video on said display surface, wherein said display surface of said electronic display is visible from a first side of said privacy window, wherein said display surface of said electronic display is not visible from a second side of said privacy window, wherein said first side of said privacy window is opposite from said second side of said privacy window;
a camera operable to capture a video stream, wherein said camera is disposed facing a second direction substantially opposite from said first direction; and
an interconnection between said electronic display and said camera operable to enable said electronic display to display at least a portion of said video stream, wherein said translucent portion and said electronic display are disposed such that a first observer disposed on said second side of said privacy window is substantially unable to observe details through said privacy window.

10. The privacy window of claim 9, further comprising a microphone facing said second direction, wherein said microphone is operable to receive an audio stream.

11. The privacy window of claim 10, further comprising a sound generating apparatus facing said first direction, wherein said sound generating apparatus is operable to reproduce said audio stream.

12. The privacy window of claim 9, further comprising a light source operable to project light from said privacy window toward said second direction.

13. The privacy window of claim 12, wherein said light source comprises at least one of a visible light source and an infrared light source.

14. The privacy window of claim 9, further comprising:
a first light sensor operable to detect a first light level incident on said front surface;
a second light sensor operable to detect a second light level incident on said rear surface; and
a brightness controller operable to adjust a brightness of said electronic display at least partially based on said first light level and said second light level.

15. The privacy window of claim 9, further comprising:
a sensor operable to detect an occupancy status on said first side of said privacy window; and
a controller operable to change the power state of said electronic display based on said occupancy status.

16. The privacy window of claim 9, wherein said electronic display is comprised of at least two discrete portions, wherein a portion of said translucent portion is disposed between said at least two discrete portions.

17. The privacy window of claim 9, wherein said video stream is divided between said at least two discrete portions such that substantially no portion of said video stream appears on more than one of said at least two discrete portions.

18. A method for providing privacy through a window of a room, said method comprising:
capturing a video stream of an area outside of said window, wherein said area outside of said window would be visible from said room through said window if said window had a portion void of visual impediment;
displaying said video stream within said window, wherein said video stream is visible to an observer within said room, wherein said video stream is not visible to an observer outside of said room and proximate to said window;
distorting a view of said room through said window such that no details of said room are visible through said window; and
passing light from outside of said room into said room through said window, wherein said capturing step, said displaying step, said distorting step, and said passing step all occur substantially simultaneously.

19. The method of claim 18, further comprising:
recording an audio stream of sound proximate to and outside of said room; and
reproducing said audio stream within said room, wherein said recording step, said reproducing step, and said displaying step all occur substantially simultaneously.

20. The method of claim 18, further comprising:
projecting light from said window toward said area outside of said window, wherein said projecting step and said capturing step occur substantially simultaneously.
